(19) United States
(12) Patent Application Publication
(10) Pub. No.: US 2014/0156188 A1
(43) Pub. Date: Jun. 5, 2014

(54) Personalized Map Routes

(71) Applicant: INTERNATIONAL BUSINESS MACHINES CORPORATION, Armonk, NY (US)

(72) Inventors: Brian W. Hart, Austin, TX (US); Anil Kalavakolanu, Austin, TX (US); Minh Michelle Quy Pham, Austin, TX (US); Vani D. Ramagiri, Austin, TX (US); Lynne Marie Weber, Austin, TX (US)

(73) Assignee: International Business Machines Corporation, Armonk, NY (US)

(21) Appl. No.: 13/693,977

(22) Filed: Dec. 4, 2012

(51) Int. Cl. G01C 21/00

(52) U.S. Cl. CPC G01C 21/00
USPC 701/538

(57) ABSTRACT

A method and implementing computer system are provided which collects annotation information from users of a mapping site, associates the annotation with particular segments of a travel route, scores the annotations and constantly adjusts the scores of the annotations in determining preferred travel routes. When a user requests a route, the relationship between requestor and annotation provider is considered, and the requestor is provided with the highest-ranked annotations in accordance with the requestor's personal preferences for driving directions. The user can request updates to the annotations if their scoring changes after the route is provided. Current weather conditions and continuous weather condition updates are also provided at predetermined intervals for selected routes of travel.

### FIELD OF THE INVENTION

The present invention relates generally to information processing systems and more particularly to a methodology and implementation for enabling personalized user input for vehicle travel routes.

### BACKGROUND OF THE INVENTION

Computerized mapping systems are being developed in order to assist motorists in determining preferred routes in traveling between two or more locations. Examples of computerized mapping systems include: Map Quest™, Yahoo! Maps™, SMART pages™, AutoPilot™, and Rand McNally™. In addition to the above examples, Mercedes Benz™ and BMW™ have incorporated similar computerized mapping systems into their automobiles' on-board computer systems.

In general, current computerized mapping systems allow a user or operator to enter a starting point and a destination point. The computerized mapping system may access a map database containing road information. Various companies offer mapping services to internet users, including calculation of a route between two endpoints. Some annotations to the travel routes are also provided. These annotations are helpful, but they are based on the map itself, i.e. they refer to highways and cross streets that can be retrieved from the mapping database. These annotations are lacking in that they are not driver-friendly, i.e. the directions provided are not easily usable by a driver who is probably driving in a new area and generally finds it extremely difficult, stressful and even dangerous to constantly try to identify street names and addresses while, at the same time, trying to drive in a safe manner and deal with current traffic and weather conditions.

Further, existing systems are frequently not up to date with regard to traffic delays which may be encountered while traveling the selected route. Such delays may be caused by new construction and/or detours which are not taken into account when a pre-programmed navigation program is created. Moreover, spontaneous or real-time factors, such as disabled vehicles or weather-related road conditions which may affect travel routes, are not taken into account at all. These shortcomings result in mapping programs which provide incomplete route information.

Additionally, there is no current system which provides users with current information regarding the aesthetics and/or other factors of a trip. For example, navigation systems do not provide current information regarding autumn tree color changes or snow accumulation along predetermined routes in a timely manner. When there are several routes to choose from, drivers may prefer to take a route with better scenic views of color changes at the time that the driver is actually taking the trip. Such spontaneous information is not available from pre-programmed static navigation systems.

Since current vehicle navigation systems use static, rather than dynamic information, changes can not be implemented in a timely manner. In addition to being out of date, the “best” route offered is usually defined by the shortest distance or time between the start and end. The updating and distribution of new routes using the currently available methods is not very efficient. The accuracy of this information is very important because of the many very critical scenarios in which auto-routing is used. As such static maps are distributed, there is a high probability that some of the routes that have been defined no longer even exist because of new roads being created, or because of temporary construction that has caused a major portion of a road to be unusable.

Individual drivers also have different personal preferences with regard to driving directions. For example, one driver may prefer to be guided by travel distances between designated intermediate points along a travel route while other drivers prefer to be guided by other types of directions such as the number of red lights, stop signs or gas stations passed before making the next turn. To date there is no known mapping system that allows for such personal preferences in providing computer-generated mapping routes. Typically, generic “one size fits all” maps are generated from a map database after a starting point and an endpoint are provided by a user.

Thus there is a need for an improved methodology and implementing mapping system which provides more accurate, user-friendly and personalized information to a user regarding computer-generated travel routing.

### SUMMARY OF THE INVENTION

A method and implementing computer system are provided which collects annotation information from users of a mapping site, associates the annotation with particular segments of a travel route, scores the annotations and constantly adjusts the scores of the annotations in determining preferred travel routes. When a user requests a route, the relationship between requestor and annotation provider is considered, and the requestor is provided with the highest-ranked annotations in accordance with the requestor's personal preferences for driving directions. The user can request updates to the annotations if their scoring changes after the route is provided. Users are enabled to provide spontaneous routing and driving condition information to a data base which is made available to other drivers on a real-time basis. Users are also enabled to define new routes between travel points and upload new route information for access by other users of the system. In an exemplary embodiment, wireless communication techniques are implemented to transfer data from a GPS device in an automobile to a data base on a central server to provide other users of the system who have access to the data base, with the current status of dynamic driving conditions in terms of a requesting user's personal preferences for driving directions as input-specified by the requesting user. Current weather conditions and continuous weather condition updates are also provided at predetermined intervals for selected routes of travel.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of a user navigation system in accordance with the present invention;

FIG. 3 is a functional block diagram of the various units which may be included in the user navigation system in accordance with one embodiment of the present invention;

FIG. 4 is a flow chart illustrating an exemplary operation in one embodiment of the present invention; and

FIG. 5 is a flow chart illustrating an update process in updating current routes;

FIG. 6 is an illustration or a route evaluation process which may be implemented in accordance with the present invention; and

FIG. 7 is an illustration of a route selection process which may be implemented in accordance with the present invention.

### DETAILED DESCRIPTION

The various methods discussed herein may be implemented within a typical computer system which includes processing means, memory, updateable storage, input means and display means, in combination with a global positioning system (GPS) and communication means for communicating information between individual user systems and a central server system accessible by users of the system. Since the individual components of a computer system which may be used to implement the computer functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention.

Most computer-generated mapping routes do not provide driver-friendly personalized information for assisting a driver to follow a computer-generated travel route. Generally, a route is specified using streets, addresses and/or highway names and distances. The present disclosure provides an improved route-mapping function which provides driver-personalized information which is better suited to assist drivers in traversing computer-generated travel routes. Users access a travel route database to input current and local information regarding predetermined areas. Each information-providing user or “annotator” is enabled to input a designator, for example a zip code or telephone area code, to identify an area with which that user is particularly familiar. The area designator may be, for example, an area in which the information provider lives and/or works. When a user of the routing system requests the routing system to provide a map or directions from one location to another, the requesting user is enabled determine that the information provider actually lives in the area in which the travel will occur and this factor will be given a higher weighting factor in determining a score for the route input by the information provider. The date and time that the input by the information provided is given are also recorded and also provide a score which may be used in evaluating the routing provided by other information providers. This feature also enables the routes to be dated and scored for how current the route information is. This creation date score may also be weighted and combined with the information provider residence and other factors to determine a total score for a recommended route. Alternatively, a user may indicate one or more factors to foe solely determinative of a recommended route between two points. For example, by appropriate input, a user may indicate that the user wishes to have a route recommended by a local resident to be the sole criterion for a recommended route or the user may assign a higher weighting factor to the residence area of the information provider over other factors such as the date and/or time of the information provider input to the mapping database. A user is enabled to indicate a preference for directions provided by residents of an area over point-to-point directions which may be generated by a computer mapping system. This feature provides a user with a greater assurance that the directions are current and accurate. In this manner, the geographic proximity of the annotation provider to the requested route is taken into account. The present disclosure also takes time into account. Annotations can be set to expire when they're no longer useful and can “come into season” at appropriate times. Current local weather conditions are also considered in the disclosed mapping system. Further, the system provides updates to the annotations for a particular route even after the one-time event of route generation (e.g. via SMS or email).

The system allows users of the mapping site to provide annotations associated with particular segments of the route. Further, users are enabled to input images associated with particular segments of the route (e.g. pictures of landmarks, intersections, etc). Users are also enabled to provide or upload sound files or recorded sounds (e.g. voice descriptions). At the time the user provides the annotation, the system also optionally collects information about the user and annotation, such as the user's area of residence or work or current geographic location (based on IP address or GPS, etc). Other information may also be included such as the past history of annotations, the user's desire to make the annotation private or public, the time the annotation was added, the user's recommended duration for the annotation, the user's association of the annotation with season or weather events, the user's association of the annotation with a travel category (e.g. “directions”, “sight seeing/scenery”, etc).

As noted earlier, annotations will have an associated score. The scores are updated based on various events such as when the annotation is first added. The scores are adjusted based on the geographic proximity of the provider and the route segment (annotations from local users score higher). As time progresses, the scores are adjusted for time-sensitive annotations. Score is lowered as an annotation reaches its expiration. The scores are also adjusted for annotations with seasonal associations, i.e. the scores may be raised as the annotation comes into season, and lowered as it goes out of season.

Users are also enabled to provide feedback on annotations. For example, scores are adjusted for individual annotations as users of the routes provide positive or negative feedback. Scores are also adjusted for other annotations from the same provider as users of the routes provide positive or negative feedback.

When a user of the site requests a route, further scoring adjustments are taken into account to determine which annotations to include. For example, the requestor may specify preferred scoring adjustments to assign a higher weighting factor to selected criteria in computing a “best score” route. The requestor may also prefer annotations of a particular category or prefer annotations from friends or prefer images or text. For all of the annotations that might apply to the chosen route scores are adjusted based on the social networking relationship between the annotation provider and the route requestor (annotations from friends score higher; non-friends or unknowns score lower). Annotations are “ruled-in” or “ruled-out” based on whether they are private and whether the route requestor is allowed access. Scores are also adjusted based on current or predicted weather conditions at the time the requestor expects to make use of the route. Thus, route scores are adjusted based on requestor's specified preferences. The scores of the annotations are then compared and the highest scoring annotations are included in the route.

After a user requests a route and receives the initial set of annotations, the scores of those annotations may be adjusted as described earlier. In addition, user may request updates to annotations via email or other means (e.g. SMS, app polling). The relative ranking of annotations may also change for example if an annotation enters or falls out of the top X for the route segment.

Users of a navigational system are allowed to record new routes and also to assign values to routes and make such information available to all users. If a user drives a route frequently and thinks others would benefit from knowing about the route, then they are enabled to define descriptive attributes that would be related to that route. These values are presented to users when trying to select a route. The act of assigning these values is known as tagging. In addition to such “user tagging”, the user will also be able to rate a road/route. This information will be made available to others through user recording, rating, tagging, and sending it to a centralized database, at which time the route becomes available for access to other users. As others use this defined route, they can also rate and tag it with their own personal values. Publishing the new routes to other users may also be dependent on rules. For instance, a new route may not be published until at least some number of users (a minimum threshold) have rated it, or until some form of user registration (and the knowledge of the individual that registration brings) has occurred. Such rules would help with the validation of a new route/road so that new routes could not be added and accessed by other drivers until they have been validated by other drivers. Applied rating values can simply be numerical (1-10) where “1” could mean “not recommended” and “10” could mean “highly recommended.” In another embodiment, a “tag” would state the basis for the recommendation. For example, a route tag may state “highly recommended for scenic viewing” or “highly recommended for niche shops”. Users of this data will use route rating to aid in making a decision about a route. Socially applied tags (Scenic, Windy, Dangerous, Congested, Deserted, Picturesque, HOV, etcetera) that the users assign will be a valuable piece of data that will help a user make a decision to choose a particular route at a current time. Thus, the combination of rating and tags will provide the human assigned values that may be more important than speed and distance, for some users.

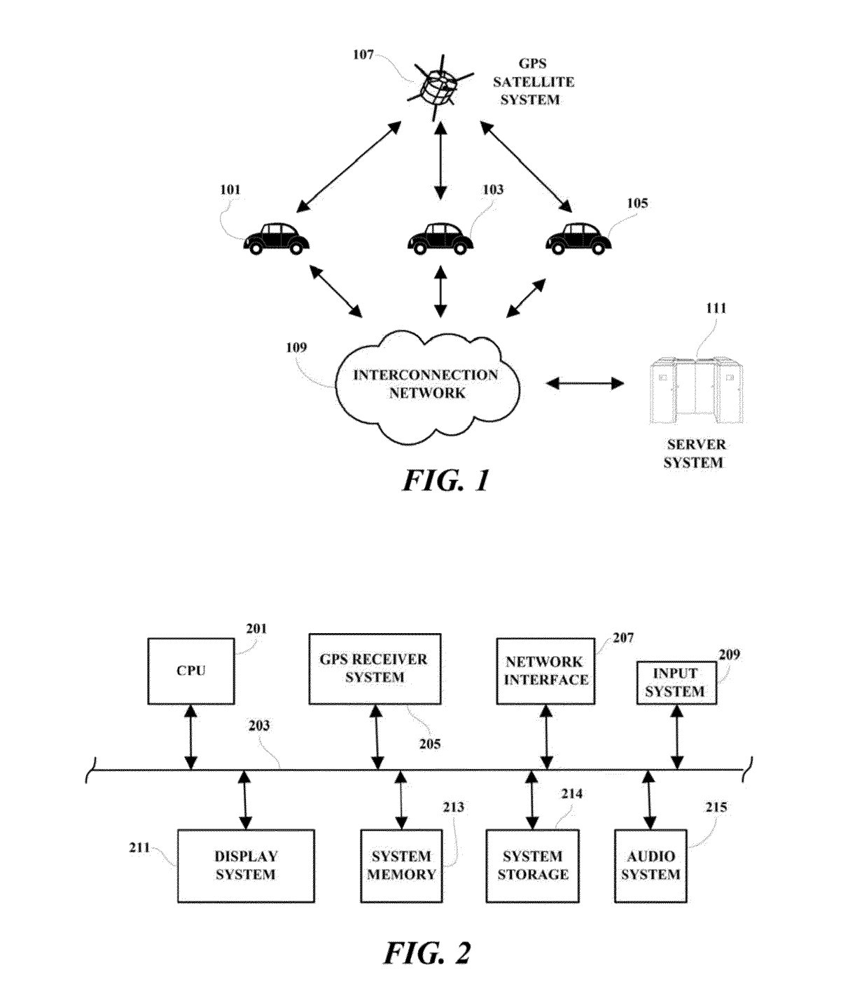

In FIG. 1, a global positioning system (GPS) 107 is in place to transmit location signals to a plurality of vehicles 101, 103 and 105. Each of the vehicles 101-103 includes a GPS system which is operable for receiving location signals from the GPS satellite 107 providing signals representative of the location of each vehicle, respectively. In addition to the GPS system, each vehicle 101-103 includes a navigation processing system which is arranged to communicate with a server 111 through an interconnection network 109, for example the Internet. With the system as shown, vehicles 101-103 are able to determine each vehicle's location at any time and transmit that location information to the server 111 where the vehicle location information is tracked and stored. The server 111 also uses the received location points received from the vehicles 101-103 to develop travel routes which are also stored and made available to other vehicle users who access the server 111.

In FIG. 2, several components of a vehicle's onboard processing system are illustrated. As shown, a CPU 201 is connected to a main bus 203. An onboard GPS receiver system 205 is also connected to the main bus 203. Other systems are also connected to the main bus 203 including, but not limited to, a network interface 207 for communicating with the server 111, an input system 209 for enabling user input to the system, a display system 211 for displaying, inter alia, routing information and selection and other menus to the user, system memory 213 and system storage 214 from which programming may be accessed and executed, and an audio system 215 for playing audio snippets or files, including rooting directions, to a user.

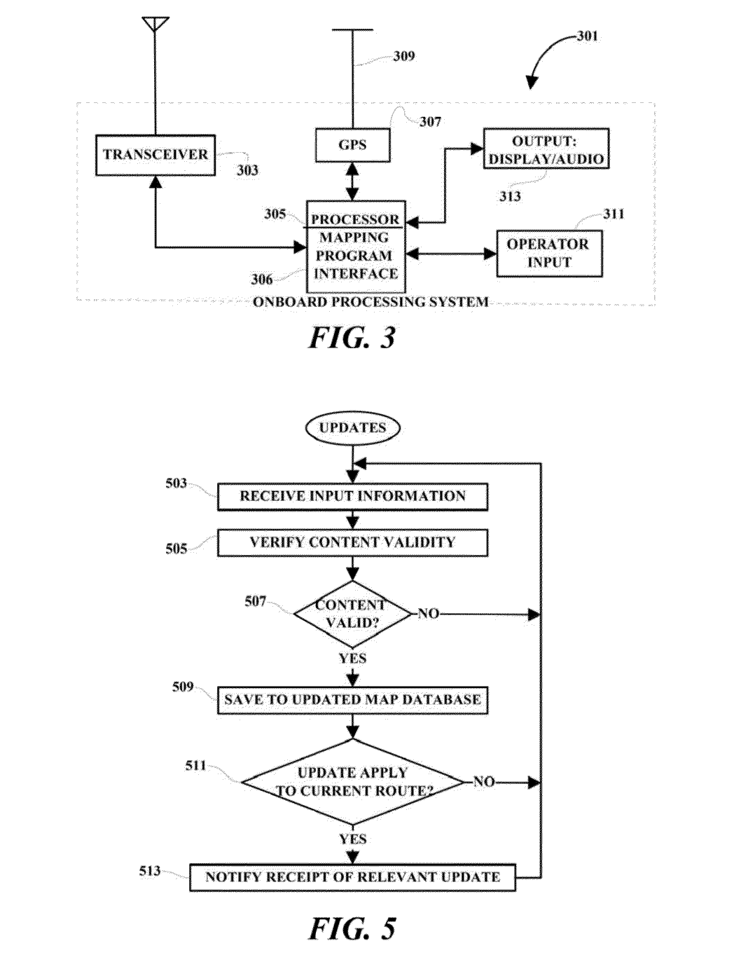

FIG. 3 shows an overall block diagram of an exemplary user system 301 which may be mounted in a user's vehicle. As shown, a transceiver 303 is arranged to communicate with a remote server, for example server 111. Transceiver 303 is coupled to a processor 305 which is, in turn, coupled to a mapping program interface 306. Mapping interface 306 contains interfacing code for communicating with the routing and storage programming for the server 111. Processor 305 also receives an input from the GPS system 307 through antenna 309. The processor 305 is arranged to receive input from a user interface 311. User input may be provided by any of many known input means, including but not limited to, full keyboard, keypad, touch-sensitive screen input, user voiced input and/or selection from a menu presented on a display device. An output unit 313 is also shown coupled to the processor 305 and arranged to provide an audio and/or video output to the system user.

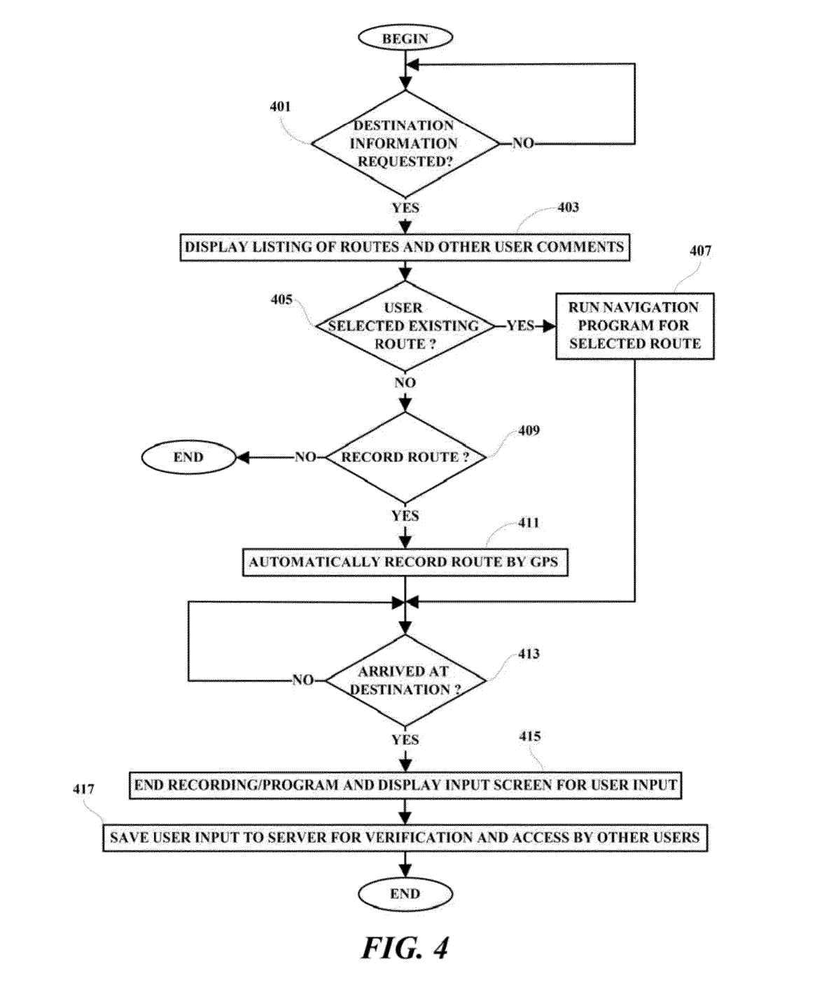

FIG. 4 shows an example of an operational flow sequence for one embodiment of the present invention. As shown, when a user requests routing information to an input destination 401, a listing of possible routes is displayed 403 to the user for selection. The routes listing in the present example, also includes user comments and other user input regarding each route. If the user selects an existing route as displayed 405, then the programmed navigation route selected by the user is audibly and/or visually presented 407 to the user as the user drives his or her vehicle to the input destination. If the user does not select an existing route from the presented listing 405, then a determination is made as to whether or not the user wishes to record a new route 409. The user may then select not to record a new route 409 and the processing is ended. However, if the user wishes to record a route other than the routes presented to the user 409, then the process continue by sampling the user's routing, for example by taking samples from the vehicle's GPS readings along the way, to automatically record 411 the user's route. After the user has arrived at a destination 413 the recording of the user's route is ended 415 and a user input screen is displayed to the user to obtain the user's comments with regard to the route taken, whether it be an existing route 407 or a newly mapped route 411. Arrival at a destination may be determined by several methods including, but not limited to, matching the GPS location of a vehicle to a known GPS location of the destination. The user's input is then saved 417 to the central server 417 for verification and for subsequent access by other system users.

An exemplary verification process is illustrated in FIG. 5. As shown, when the user's input is received 503, a verification process is initiated 505 and if the input is found to be valid 507, the user input is saved to a map data base 509. The verification process may be omitted or may be comprised of a simple check to determine if at least two users have provided the same information. In one example, after saving the user input data or after verification, the user input can be spontaneously checked against routes currently being traveled by other users 511 and if any of the other users are traveling the same or related routes, those users may be contacted 513 with the updated information from a user who has just traveled the route. In this manner, all system users can be made aware of current and developing traveling conditions along a given route which has just very recently been traveled by another system user.

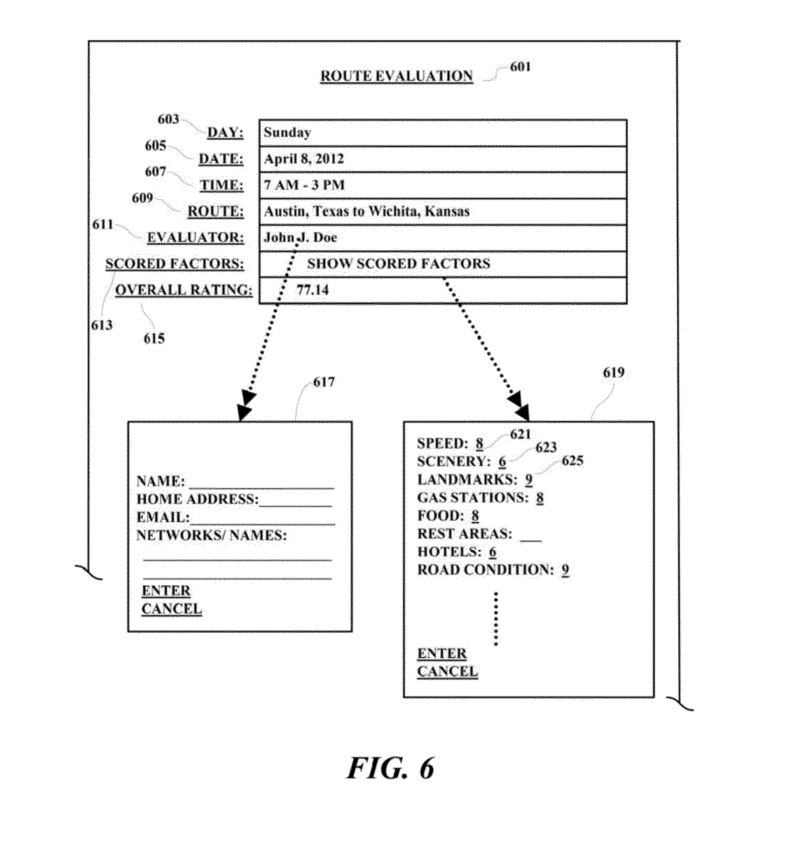

FIG. 6 shows an exemplary route evaluation screen 601 which may be implemented to receive a user's evaluation of a traveled route. As illustrated, there are several fields presented in which a user may provide input, including, but not limited to, the day of travel 603, the date 605, the time of travel 607, the route taken 609 which may be between end points for brevity, the evaluator or traveler providing the input 611, the travel factors that were scored by the evaluator 613 and an overall rating for the route 615 which is the average of all of the rated factors and may be expressed as a percent of “100” such that a higher number indicates a better route. If the evaluator “clicks on”, points to or otherwise highlights the “Evaluator” hypertext 611, another window 617 will appear in which the evaluator may enter his or her name, address, email, and social networks or websites, and the evaluator's user names for the websites such that a user of the navigation system in selecting a route to travel may access additional information of the evaluator so that, for example, the user can determine how close the evaluator lives to the route selected. This will provide an indication of how familiar the evaluator is with the route and will be helpful in choosing the best route as far as the traveler is concerned. In some cases, the traveler may be searching for a particular evaluator whom the traveler has heard provides very precise directions.

If the evaluator chooses to “SHOW SCORED FACTORS” 613, then another window 619 will appear to enable the evaluator to provide a “score” for various factors affecting the travel route. As shown, each factor is given a subjective score ranging from “1” to “10” in the present example, and the overall rating 615 is the average of the scores for each factor which was rated. All listed factors do not have to be rated and the factors that are not rated will not be included in the overall score.

In the illustrated example, the listed factors considered in each travel route include, average speed 621, the scenery 623 and landmarks 625. Other factors such as the number of gas stations, the availability of food services, the number or frequency of rest areas, the number of hotels and also the road conditions for the trip. The road conditions will be scored low for example, if there is a substantial amount of road construction along the route. In the example, the score given for road conditions is a relatively high score of “9” meaning that there was not much road construction or rough road during the trip taken by the evaluator. Factors other than those listed in FIG. 6 may also be included. For example, the weather conditions along a travel route are also a factor. A travel-routing server system may be configured to acquire weather information from a weather-related site or another traveler and then automatically update weather conditions along given route segments as the weather changes. This dynamic update information will be presented to users (not shown) who select or have selected the weather-affected routes. The weather updates may occur at predetermined intervals in travel time or distance traveled or even “on demand” as may be selected by a user The updates may also occur in response to a rate of change of the weather conditions such that weather conditions along a given route will be displayed more frequently for rapidly changing weather conditions.

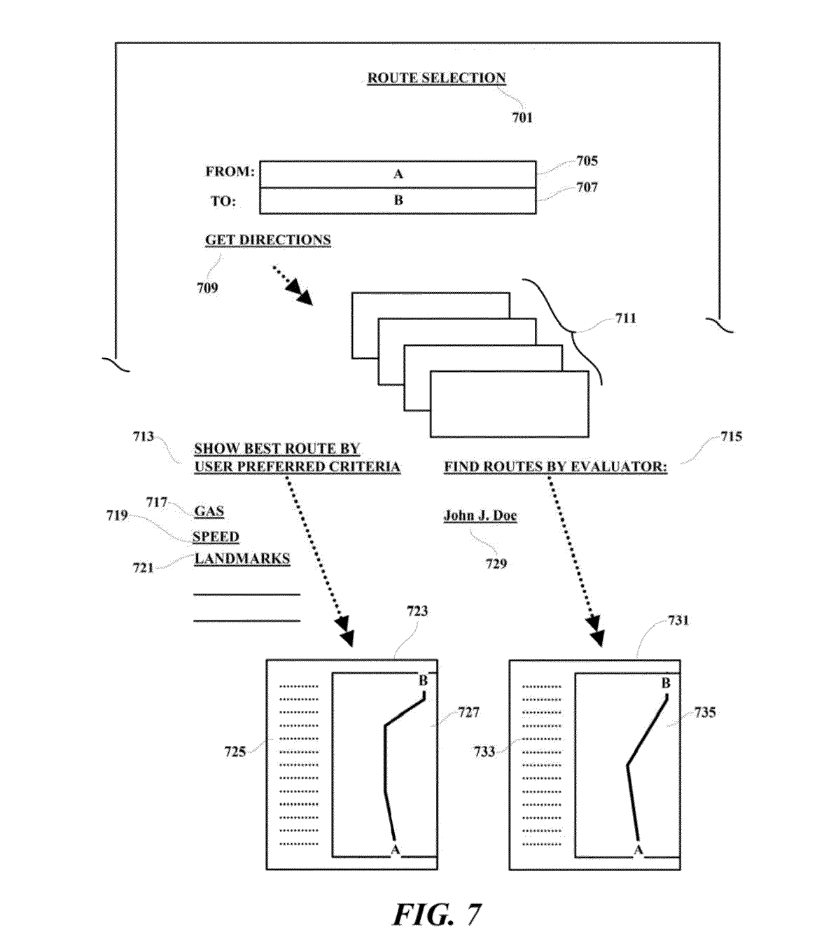

As shown in FIG. 7, a route selection screen 701 is presented to a user of the navigation system. The user enters the starting point “A” 705 and the ending point “B” 707 and selects the GET DIRECTIONS hypertext 709. Next, a group of routes 711 is indicated as possible routes between the beginning point A and the endpoint B. The user may then select either to show the best route by user-preferred or user-personalized criteria 713 or select to find a specific route evaluator 715 whom the user knows provides clear and precise directions for example. If the user selects to select a route by the user's personal preference criteria 713, the user is enabled to input the specific criteria which the user considers important.

As shown, the user inputs the availability of gas stations 717, the overall speed of the trip 719 and the number of landmarks 721 as being of greater importance in determining a “best route”. As used herein, the term “landmarks” refers to any easily perceptible sight or sound along the route of travel. For example, landmarks may include schools, churches, stop lights, stop signs, gas stations, railroad crossings, Interstate or other major intersections, lakes, office or other buildings, malls, stores, etc. In general, anything that can be easily seen along the route. Landmarks may also be classified as “day only” or “night visible” to help a user of the system determine a best route. After indicating which factors are most personally important to the traveler, a route map will be displayed 723 which includes written directions along one side 725 and a map on the other side 727 for travel between points A and B in which the traveler's personally favorite factors have scored the highest among the routes available 711. If the traveler selects to find a route mapped by a certain person 715, a route map will be displayed 731 which includes written directions along one side 733 and a map on the other side 735 for travel between points A and B.

The flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is understood that the specific example presented herein is not intended to be limiting since the functional combinations disclosed herein may be implemented in many different environments and applications including, for example, applications involving the visualization of business processes and movement of emails, task lists, task list items and other system data components within an overall system data containment environment or application.

The method, system and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a computer program product comprising a computer-readable, tangible storage device(s) and computer-readable program instructions stored on the computer-readable, tangible storage device(s) in any portable or fixed, volatile or non-volatile memory device, including CDs, RAM and “Flash” memory, or other semiconductor, optical, magnetic or other memory device capable of storing code. The disclosed methodology may also be implemented using any available input and/or display systems including touch-sensitive screens and optically-sensitive input pads. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. (canceled)

2. (canceled)

3. (canceled)

4. (canceled)

5. (canceled)

6. (canceled)

7. (canceled)

8. A computer program product comprising a computer-readable, tangible storage device(s) and computer-readable program instructions stored on the computer-readable, tangible storage device(s) for processing travel-related information within a vehicle routing system, the computer-readable program instructions, when executed by a processing system, being operable for implementing a method comprising:
providing a listing of factors related to various aspects of travel between first and second locations of a travel mate;
associating said factors with travel routes between said first and second locations;
saving said factors and said associated travel routes; and
enabling a user to select only user-preferred ones of said factors in requesting travel directions between said first and second locations.

9. The computer program product as set forth in claim 8 wherein said method further includes:
providing directions between said first and second locations in response to receiving a request from said user for said travel directions, said directions being based upon said selection of said user-preferred ones of said factors.

10. The computer program product as set forth in claim 9 wherein said method further includes:
enabling a route evaluator to provide a variable rating indicia for a plurality of selected ones of said factors; and
associating said rating indicia with appropriate ones of said factors for one or more of said travel routes.

11. The computer program product as set forth in claim 10 wherein said providing directions is based upon values of said variable rating indicia associated with said user-preferred factors for said travel routes.

12. The computer program product as set forth in claim 11 wherein said method further includes:
enabling an input of an identity of said route evaluator for each of said travel routes for which said route evaluator has provided variable rating indicia; and
enabling a traveler to designate a particular route evaluator in said request for said travel directions.

13. The computer program product as set forth in claim 12 wherein said variable rating indicia is a rating number within a range of numbers wherein said evaluator is enabled to assign a different rating number for each of said factors.

14. The computer program product as set forth in claim 13 wherein said method further includes providing an overall rating for each travel route based upon a combination of all of said rating numbers input by said evaluator for only said user-preferred factors associated with said travel route.

15. A processing system for processing travel-related information within a vehicle routing system, said processing system comprising:
a processor for providing a listing of factors related to various aspects of travel between first and second locations of a travel route;
said processor being operable for associating said factors with travel routes between said first and second locations;
a memory for saving said factors and said associated travel routes; and
an input device being operable for enabling a user to select only user-preferred ones of said factors in requesting travel directions between said first and second locations.

16. The processing system as set forth in claim 15 wherein said processor is operable for providing directions between said first and second locations in response to receiving a request from said user for said travel directions, said directions being based upon said selection of said user-preferred ones of said factors.

17. The processing system as set forth in claim 16 wherein said processor is operable for enabling a route evaluator to provide a variable rating indicia for a plurality of selected ones of said factors, said processor being further operable for associating said rating indicia with appropriate ones of said factors for one or more of said travel routes.

18. The processing system as set forth in claim 17 wherein said providing directions is based upon values of said variable rating indicia associated with said user-preferred factors for said travel routes.

19. The processing system as set forth in claim 18 wherein said input device is operable for enabling an input of an identity of said route evaluator for each of said travel routes for which said route evaluator has provided variable rating indicia, said input device being further operable for enabling a traveler to designate a particular route evaluator in said request for said travel directions.

20. The processing system as set forth in claim 19 wherein said variable rating indicia is a rating number within a range of numbers wherein said evaluator is enabled to assign a different rating number for each of said factors.
